(19) United States
(12) Patent Application Publication
(10) Pub. No.: US 2026/0343414 A1
(43) Pub. Date: Oct. 29, 2026

(54) NEIGHBOR CELL MEASUREMENT IN AN ENERGY EFFICIENT POWER STATE

(71) Applicant: Lenovo (United States) Inc., Morrisville, NC (US)

(72) Inventors: Hossein Bagheri, Urbana, IL (US); Karthikeyan Ganesan, Nauheim (DE); Ali Ramadan Ali, Kraiburg (DE)

(73) Assignee: Lenovo (United States) Inc., Morrisville, NC (US)

(21) Appl. No.: 19/464,555

(22) Filed: Jan. 29, 2026

(51) Int. Cl. H04W 52/02; H04B 17/318

(52) U.S. Cl. CPC H04W 52/0235; H04B 17/328

(57) ABSTRACT

Various aspects of the present disclosure relate to neighbor cell measurement in a power state. An apparatus, such as a user equipment (UE), transitions to a power state within a sleep state, the power state configured to enable the UE to perform data processing associated with cell measurement in the sleep state. The UE performs one or more neighbor cell measurements in the power state, where the one or more neighbor cell measurements are performed based at least in part on one or more capabilities associated with the power state and one or more capabilities associated with a reference power state.

### TECHNICAL FIELD

The present disclosure relates to wireless communications, and more specifically to energy conservation in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to transition to a power state within a sleep state, the power state configured to enable the UE to perform data processing associated with cell measurement in the sleep state; and perform one or more neighbor cell measurements in the power state, wherein the one or more neighbor cell measurements are performed based at least in part on one or more capabilities associated with the power state and one or more capabilities associated with a reference power state.

A processor (e.g., a standalone processor chipset, or a component of a UE) for wireless communication is described. The processor may be configured to, capable of, or operable to perform one or more operations as described herein. For example, the processor may be configured to, capable of, or operable to transition to a power state within a sleep state, the power state configured to enable the UE to perform data processing associated with cell measurement in the sleep state; and perform one or more neighbor cell measurements in the power state, wherein the one or more neighbor cell measurements are performed based at least in part on one or more capabilities associated with the power state and one or more capabilities associated with a reference power state.

A method performed or performable by a UE for wireless communication is described. The method may include transitioning to a power state within a sleep state, the power state configured to enable the UE to perform data processing associated with cell measurement in the sleep state; and performing one or more neighbor cell measurements in the power state, wherein the one or more neighbor cell measurements are performed based at least in part on one or more capabilities associated with the power state and one or more capabilities associated with a reference power state.

In some implementations of the UE, the processor, and the method described herein, the one or more capabilities associated with the power state include one or more of a power capability associated with the power state, or a data processing capability associated with the power state.

In some implementations of the UE, the processor, and the method described herein, the one or more capabilities associated with the power state include one or more of a minimum/maximum power capability associated with the power state, or a minimum/maximum data processing capability associated with the power state.

In some implementations of the UE, the processor, and the method described herein, the one or more capabilities associated with the reference power state include one or more of a reference power state or a reference data processing capability associated with the reference power state.

In some implementations of the UE, the processor, and the method described herein, the power state is associated with one or more of hardware availability or data processing availability in the power state.

In some implementations of the UE, the processor, and the method described herein, the UE, the processor, and the method may further be configured to, capable of, operable to, performed to, or performable to determine that the UE is in the power state within a time threshold of initiation of the power state.

In some implementations of the UE, the processor, and the method described herein, the one or more capabilities associated with the power state include one or more of one or more measurement capabilities for a total number of frequency cells, one or more measurement capabilities for a number of intra-frequency cells, one or more measurement capabilities for a number of inter-frequency cells, one or more measurement capabilities for a number of inter-radio access technology (RAT) cells, a measurement time budget for intra-frequency cells, a measurement time budget for inter-frequency cells, or a measurement time budget for inter-RAT cells.

In some implementations of the UE, the processor, and the method described herein, the measurement time budget for intra-frequency cells, the measurement time budget for inter-frequency cells, or the measurement time budget for inter-RAT cells includes a measurement time budget for one or more of: detecting a new cell that has not been detected; performing measurement on a cell according to a number of desired measurements per measurement window, wherein the measurement window and a number of measurements per measurement window are determined at least based on the measurement time budget and a measurement relaxation factor; or evaluating whether a newly detected or previously detected cell meets a cell reselection criterion.

In some implementations of the UE, the processor, and the method described herein, the reference power state includes a synchronization signal block (SSB) processing state, and wherein the SSB processing state includes a non-sleep state or a micro-sleep state.

In some implementations of the UE, the processor, and the method described herein, the UE, the processor, and the method may further be configured to, capable of, operable to, performed to, or performable to use the SSB processing state for one or more of time-frequency synchronization or reference signal received power (RSRP) and/or reference signal received quality (RSRQ) measurement of a serving cell and/or a set of neighbor cells of the UE.

An NE (e.g., a base station) for wireless communication is described. The NE may be configured to, capable of, or operable to perform one or more operations as described herein. For example, the NE may be configured to, capable of, or operable to transmit measurement configuration for neighbor cell measurement of a user equipment (UE) in a power state within a sleep state, the power state configured to enable the UE to perform data processing associated with cell measurement in the sleep state, wherein the measurement configuration comprises one or more capabilities associated with a UE power state and one or more capabilities associated with a UE reference power state.

The power state (e.g., energy efficient power state) may refer to an energy efficient (EE) processing state, and a UE within the energy efficient power state is capable of processing one or more signals including a DL WUS (wakeup signal) of OFDM-based sequence(s) for at least wake-up indication and, if applicable, other signal(s) of OFDM-based sequence(s) for synchronization and/or measurement, in an energy efficient manner. EE processing may be performed during a sleep state with additional relative power value added with respect to the sleep state and without triggering UE transition out of the sleep state.

A processor (e.g., a standalone processor chipset, or a component of a NE) for wireless communication is described. The processor may be configured to, capable of, or operable to perform one or more operations as described herein. For example, the processor may be configured to, capable of, or operable to transmit measurement configuration for neighbor cell measurement of a user equipment (UE) in a power state within a sleep state, the power state configured to enable the UE to perform data processing associated with cell measurement in the sleep state, wherein the measurement configuration comprises one or more capabilities associated with a UE power state and one or more capabilities associated with a UE reference power state.

A method performed or performable by an NE (e.g., a base station) for wireless communication is described. The method may include transmitting measurement configuration for neighbor cell measurement of a user equipment (UE) in a power state within a sleep state, the power state configured to enable the UE to perform data processing associated with cell measurement in the sleep state, wherein the measurement configuration comprises one or more capabilities associated with a UE power state and one or more capabilities associated with a UE reference power state.

In some implementations of the NE, the processor, and the method described herein, the reference power state includes a SSB processing state.

### BRIEF DESCRIPTION OF THE DRAWINGS

FIG. 1 illustrates an example of a wireless communications system in accordance with aspects of the present disclosure.

FIG. 2 illustrates an example procedure in accordance with aspects of the present disclosure.

FIG. 3 illustrates an example of a UE in accordance with aspects of the present disclosure.

FIG. 4 illustrates an example of a processor in accordance with aspects of the present disclosure.

FIG. 5 illustrates an example of an NE in accordance with aspects of the present disclosure.

FIG. 6 illustrates a flowchart of a method in accordance with aspects of the present disclosure.

FIG. 7 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. When a UE is not actively engaged in data transmission or reception using time-frequency resources, the UE may operate in idle or inactive radio resource control (RRC) states. During these states, the UE may perform cell selection and cell reselection procedures to maintain connectivity with a serving cell. When the UE is camped on a serving cell, cell reselection events may occur which involve the UE monitoring neighboring cells and evaluating whether a different cell may provide better service based on signal quality measurements and priority considerations.

To perform cell reselection, a UE may measure synchronization signals, broadcast signals, and/or reference signals from both its serving cell and neighboring cells. Neighboring cells may include intra-frequency cells operating on the same carrier frequency, inter-frequency cells operating on different carrier frequencies, and inter-RAT cells operating on different radio access technologies. Measurements of a serving cell and neighboring cells may include measurements of RSRP and RSRQ derived from SSB. A UE may evaluate these measurements against various thresholds and criteria to determine whether to remain camped on the current serving cell or reselect to a neighboring cell.

Measurement procedures for cell reselection can involve timing parameters that specify how quickly the UE detects new cells, how frequently measurements are performed, and how rapidly the UE evaluates whether cells meet reselection criteria. These timing parameters may be associated with measurement budgets that the UE follows during idle and inactive mode operation. The UE may also apply measurement relaxation under certain conditions, such as when the serving cell quality is sufficiently high or when the UE exhibits low mobility, to reduce power consumption while maintaining adequate mobility performance.

Power consumption is a consideration for UEs and various power states exist for UE operation, ranging from active states where a UE performs full processing to sleep states where portions of the UE hardware are powered down to conserve energy. Different sleep states provide different levels of power savings, with deeper sleep states enabling greater power reduction but involving longer transition times to return to active operation. Energy efficient power states may allow limited processing to occur within sleep states without fully transitioning the UE out of a sleep state.

Performing neighbor cell measurements while maintaining low power consumption presents challenges. Measurement requirements and capabilities have been specified for UE operation in non-sleep states where full processing resources are available. When a UE operates in an energy efficient state within a sleep state, the available processing capability and power budget may differ from those available during normal operation. Adapting neighbor cell measurement procedures to account for the characteristics of energy efficient states within various sleep states thus presents challenges.

Aspects of the present disclosure are described in the context of a wireless communications system, and include implementations that provide neighbor cell measurement parameters for a UE in different energy efficient power states within different types of sleep states. For example, time detect (T_{detect}) represents the time within which a newly detectable neighbor is to meet cell reselection criteria. Time measure (Tₘₑₐₛᵤᵣₑ) represents a time to measure SS-RSRP and SS-RSRQ at least every Tₘₑₐₛᵤᵣₑ for cells that are identified and measured. Time evaluate (Tₑᵥₐₗᵤₐₜₑ) represents a time for a cell that has been already detected but not reselected from a current serving cell. In implementations, T_{detect}, Tₘₑₐₛᵤᵣₑ, and Tₑᵥₐₗᵤₐₜₑ may be defined per energy efficient power state and per sleep state. In implementations, a number of cells that a UE can monitor in an energy efficient power state can be specified or determined based on a relative power of the energy efficient power state with respect to a reference non-sleep state. In implementations, each energy efficient power state (also referred to herein as “power state”) has a respective power level distinct from other energy efficient power states, and each respective power level for the energy efficient power states remains below a threshold that may trigger the UE to transition out of the sleep state. Measurement relaxation may be defined per energy efficient power state within a specific sleep state. Measurement relaxation or measurement dropping may be performed for some neighbor cells to reduce the processing load in an energy efficient power state.

By performing the described techniques, a device (e.g., UE) in a wireless communications system can reduce power usage (e.g., conserve battery power) while maintaining the quality of wireless communication in the wireless communication system.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

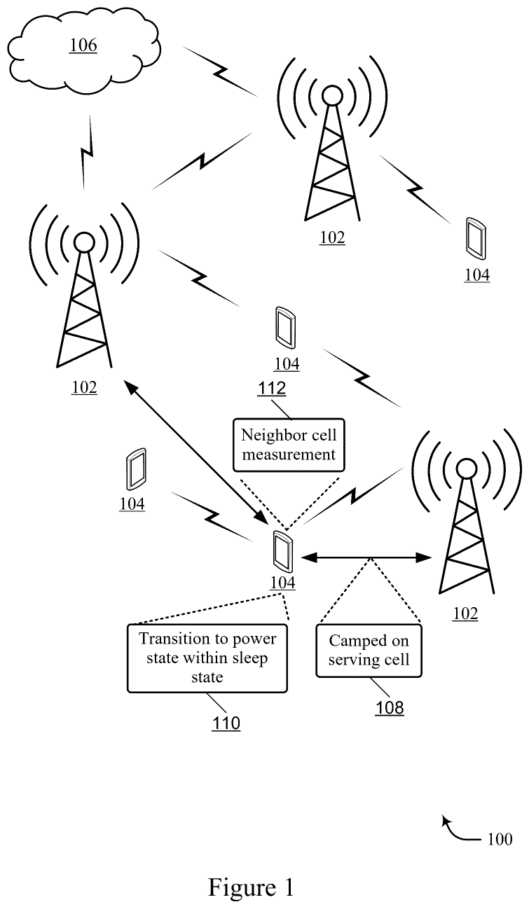

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, at 108 a UE 104 is camped on a serving cell. At 110 the UE 104 may transition to a power state within a sleep state, the power state configured to enable the UE to perform data processing associated with cell measurement in the sleep state. At 112, the UE 104 may perform one or more neighbor cell measurements of one or more NEs 102 in the energy efficient power state within the sleep state, where the one or more neighbor cell measurements are performed based at least in part on one or more capabilities associated with the energy efficient power state and one or more capabilities associated with a reference power state.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

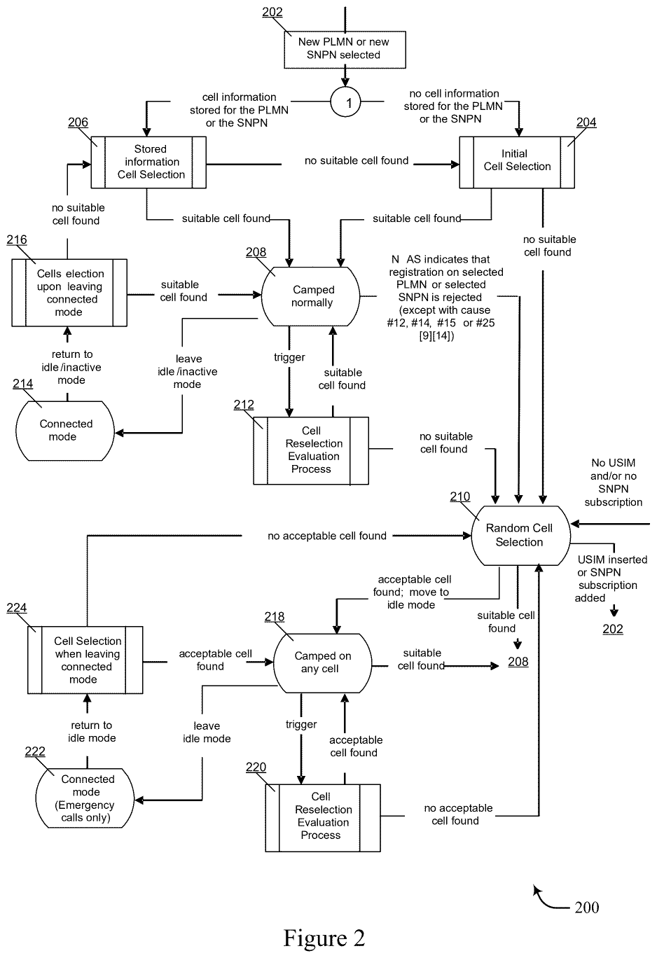

FIG. 2 illustrates an example procedure 200 in accordance with aspects of the present disclosure. The procedure 200, for example, illustrates UE states, state transitions, and procedures in RRC_IDLE and RRC_INACTIVE. At 202, a UE selects a new public land mobile network (PLMN) or a new stand-alone non-public network (SNPN). If no cell information is stored for the PLMN or the SNPN, at 204 initial cell selection is performed. If cell information is stored for the PLMN or the SNPN, at 206 the stored information is used to select a cell. If at 206 no suitable cell is found, the procedure 200 proceeds to 204. If at 204 and/or 206 a suitable cell is found, at 208 the UE camps on the suitable cell. If at 204 a suitable cell is not found, at 210 the UE performs random cell selection. If at 208 a reselection trigger occurs, at 212 a cell reselection evaluation process is performed and if a suitable cell is found, at 208 the UE camps on the suitable cell. If at 212 a suitable cell is not found, at 210 the UE performs random cell selection. If at 208 the UE leaves an idle/inactive mode, at 214 the UE transitions to a connected mode. If the UE then returns to an idle/inactive mode, at 216 the UE performs cell selection upon leaving connected mode. The procedure 200 may then proceed to 208 if a suitable cell is found or to 206 if a suitable cell is not found.

If at 208 the NAS indicates that registration on a selected PLMN or a selected SNPN is rejected, or if at 212 no suitable cell is found, the procedure 200 proceeds to 210. If a UE does not have a universal subscriber identity module (USIM) and the UE does not have a subscription for an SNPN, the process may proceed to 210. When a USIM is installed in the UE and/or an SNPN subscription is added, the procedure 200 may proceed to 202. If at 210 a suitable cell is found, the procedure 200 may proceed to 208. If at 210 an acceptable cell is found and the UE moves to idle mode, at 218 the UE can camp on any cell. If at 218 a suitable cell is found, the procedure 200 may proceed to 208. If at 218 a cell reselection trigger occurs, at 220 a cell reselection evaluation process is executed. If at 220 an acceptable cell is found the procedure 200 proceeds to 218 and if at 220 an acceptable cell is not found, the procedure 200 proceeds to 210. If at 218 the UE leaves the idle mode, at 222 the UE may enter connected mode, such as for emergency calls. If at 222 the UE returns to idle mode, at 224 the UE may perform cell selection when leaving connected mode. If at 224 an acceptable cell is not found, the procedure 200 may proceed to 210. If at 224 an acceptable cell is found, the procedure 200 may proceed to 218.

In implementations, a cell selection process can be performed via initial cell selection or via cell selection using stored information. In initial cell selection (e.g., with a UE having no prior knowledge of which RF channels are NR frequencies), the UE may scan all RF channels in the NR bands according to its capabilities to find a suitable cell. On each frequency, the UE may search for the strongest cell, except for operation with shared spectrum channel access where the UE may search for the next strongest cell(s). Once a suitable cell is found, the UE may select the cell.

For cell selection using stored information, stored information of frequencies and optionally information on cell parameters from previously received measurement control information elements or from previously detected cells may be used. When the UE has found a suitable cell, the UE may select the suitable cell. If no suitable cell is found, an initial cell selection procedure may be performed.

Cell selection criteria may be utilized and the cell selection criteria S may be fulfilled when:
Srxlev>0 AND Squal>0
where:

Srxlev=Qᵣₓₗₑᵥₘₑₐₛ−(Qᵣₓₗₑᵥₘᵢₙ+Q_{rxlevminoffset})−P_{compensation}−Q_{offsettemp}

Squal=Q_{qualmeas}−(Q_{qualmin}+Q_{qualminoffset})−Q_{offsettemp}

where:

Table 1 provides example attributes of cell selection criteria:

TABLE 1

| Srxlev | Cell selection RX level value (dB) |
|---|---|
| Squal | Cell selection quality value (dB) |
| Qoffsetₜₑₘₚ | Offset temporarily applied to a cell as specified in TS |
| | 38.331 [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the |
| | UE supports SUL frequency for this cell, Qᵣₓₗₑᵥₘᵢₙ is |
| | obtained from q-RxLevMinSUL, if present, in SIB1, SIB2 |
| | and SIB4, additionally, if Q_{rxlevminoffsetcellSUL} is present in |
| | SIB3 and SIB4 for the concerned cell, this cell specific |
| | offset is added to the corresponding Qᵣₓₗₑᵥₘᵢₙ to achieve |
| | the required minimum RX level in the concerned cell; |
| | else Qᵣₓₗₑᵥₘᵢₙ is obtained from q-RxLevMin in SIB1, |
| | SIB2 and SIB4; additionally, if Q_{rxlevminoffsetcell} is present in |
| | SIB3 and SIB4 for the concerned cell, this cell specific |
| | offset is added to the corresponding Qrxlevmin to achieve |
| | the required minimum RX level in the concerned cell. |
| Q_{qualmin} | Minimum required quality level in the cell (dB). |
| | Additionally, if Q_{qualminoffset}cell is signalled for the |
| | concerned cell, this cell specific _{offset} is added to achieve |
| | the required minimum quality level in the concerned cell. |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN, as specified in TS 23.122 [9]. |
| Q_{qualminoffset} | Offset to the signalled Q_{qualmin} taken into account in the |
| | Squal evaluation as a result of a periodic search for a higher |
| | priority PLMN while camped normally in a VPLMN, asspecified in TS 23.122 [9]. |
| P_{compensation} | For FR1, if the UE supports the additionalPmax in the |
| | NR-NS-PmaxList, if present, in SIB1, SIB2 and SIB4: |
| | max(P_{EMAX1}-P_{PowerClass}, 0)-(min(P_{EMAX2}, P_{PowerClass})- |
| | min(P^{EMAX1}, P_{PowerClass})) (dB); |
| | else: |
| | max(P_{EMAX1}-P_{PowerClass}, 0) (dB) |
| | For FR2, P_{compensatio}n is set to 0. |
| | For IAB-MT, P_{compensation} is set to 0. |
| P_{EMAX1}, P_{EMAX2} | Maximum TX power level of a UE that may be used |
| | when transmitting on the uplink in the cell (dBm) defined |
| | as P_{EMAX} in TS 38.101 [15]. If the UE supports SUL |
| | frequency for this cell, P_{EMAX1} and P_{EMAX2} are obtained |
| | from the p-Max for SUL in SIB1 and NR-NS-PmaxList for |
| | SUL respectively in SIB1, SIB2 and SIB4 as specified in |
| | TS 38.331 [3], else P_{EMAX1} and P_{EMAX2} are obtained from |
| | the p-Max and NR-NS-PmaxList respectively in SIB1, SIB2 |
| | and SIB4 for normal UL as specified in TS 38.331 [3]. |
| P_{PowerClass} | Maximum RF output power of the UE (dBm) |
| | according to the UE power class as defined in TS 38.101- |
| | 1 [15]. |

The signalled values Q_{rxlevminoffset} and Q_{qualminoffset} may be applied when a cell is evaluated for cell selection as a result of a periodic search for a higher priority PLMN while camped normally in a virtual PLMN (VPLMN). During this periodic search for higher priority PLMN, the UE may check the S criteria of a cell using parameter values stored from a different cell of this higher priority PLMN.

Cell selection evaluation (e.g., initial cell entry and/or cell reentry) may represent the evaluation that the UE performs the first time the UE attempts to camp on a cell. This may occur after initial acquisition of SSB (primary synchronization signal (PSS)/secondary synchronization signal (SSS)/physical broadcast channel (PBCH)/master information block (MIB)) and/or system information block 1 (SIB1) (and other SIBs if needed). The UE, for example, determines whether a cell is acceptable and suitable for camping. As part of the cell selection evaluation, the UE may measure SSB RSRP (Reference Signal Received Power from SS/PBCH) and SSB RSRQ (Reference Signal Received Quality). The UE may use RSRP/RSRQ (e.g., normalized signal quality) metrics for both selection and reselection, which are measured over synchronization signal blocks.

Different criteria may be utilized to determine whether a cell is acceptable for UE connectivity. For example, in some scenarios, a cell may be acceptable for UE connectivity if:
Srxlev>=0;
(if used) Squal≥0;
PLMN is allowed;
TAC (Tracking Area Code) not forbidden;
Cell not barred

In implementations, after a UE performs physical evaluation of a cell, PLMN is checked, forbidden lists are checked, and SNPN restrictions apply. If the cell is acceptable, the UE may camp on the cell, begin monitoring paging, and start neighbor measurements for later reselection. If the cell is not acceptable, the UE continues scanning for other cells. For instance, in RRC-Idle mode the UE may perform RRC-IDLE-LOOP including neighbor measurement (collect RSRP/RSRQ), neighbor evaluation (ranking/thresholds), cell reselection (e.g., change cell camp if a better cell is identified), etc.

Implementations may include cell reselection, such as when a UE is in an idle/inactive state. In implementations, cell reselection represents a periodic mobility procedure performed when a UE is already camped and attempts to identify a better cell. Cell reselection may occur periodically, when signal conditions change, when neighbor cells become sufficiently stronger, and/or when priority suggests a better frequency. A UE may perform reselection without involvement of the network. Cell reselection types include intra-frequency reselection (e.g., same EARFCN/NR-ARFCN but different PCI (cell ID)), inter-frequency reselection, different NR frequency layers, inter-RAT reselection (e.g., NR→LTE), etc.

In implementations, reselection may use ranking formulas. For example, neighbor cells and serving cells may be ranked based on RSRP, RSRQ, priority values, hysteresis, S-criteria (e.g., strength/quality). For intra-frequency reselection, a ranking formula for candidate cell i may be:

Ranking_i=Qrxlevmeasi+Qoffset_temp

### Where:

Qrxlevmeasi=measured RSRP for neighbor i
Qoffset_temp=optional offset for filtering/hysteresis

For a serving cell a ranking metric may be specified as:

### If:

Ranking_neighbor>Ranking_serving+Hys
AND other criteria are satisfied:
   Reselection to neighbor cell

For inter-frequency reselection, frequency priority may be considered. For example, for a priority check, a UE may check for neighbor frequencies with a higher priority. Among those frequencies, the UE may select a best cell if measured quality is acceptable. In implementations, priority values may be broadcast in SIB5.

In implementations, inter-frequency ranking steps may include (1) Check priority list; (2) perform measurement on that band; evaluate Srxlev/Squal for each candidate; (3) compute ranking metrics; (4) reselect cell if better than a serving cell. A neighbor cell i may become a new serving cell if:
1) Priority(i)≥Priority (serving cell)
AND
2) Srxlev≥i 0
AND
3) Squal_i≥0 (if used)
AND
4) Ranking_i>Ranking_serving+Hys
AND
5) Timer tresel(i) expired
When all true:
→UE camps on cell i

For cell measurement, different measurement time budgets can be utilized. For example, time detect (T_{detect}) represents the time within which a newly detectable neighbor is to meet the reselection criterion. Time measure (Tₘₑₐₛᵤᵣₑ) represents a time to measure SS-RSRP and SS-RSRQ at least every Tₘₑₐₛᵤᵣₑ for cells that are identified and measured. For example, at least 2 measurements are included in a filter, separated by at least Tₘₑₐₛᵤᵣₑ/2. Time evaluate (Tₑᵥₐₗᵤₐₜₑ) represents a time for a cell that has been already detected, but that has not been reselected to, and the filtering shall be such that the UE shall be capable of evaluating that the cell has met reselection criterion. Table 2 specifies different attributes of non-sleep states.

TABLE 2

| | | Relative Power | Relative Power in |
|---|---|---|---|
| | | in FR1 | FR2 (including |
| | | (including | 24.25 GHz-52.6 |
| Power State | Characteristics | around 7GHz) | GHz) |
| EE | Processing DL WUS of OFDM-based | 10/X1 (during | |
| Processing | sequence(s) for at least wake-up indication | micro sleep) | |
| | and, if applicable, other 6 GR signal(s) of | 12/X2 (during | |
| | OFDM-based sequence(s) for | light sleep) | |
| | synchronization and/or measurement, in an | 15/X3 (during | |
| | energy efficient manner, based on the | | |
| | following configuration: | | |
| | FR1 (including around 7 GHz) | | |
| | 5 MHz BW, 1-RX/2-RX for | | |
| | reception; | | |
| | Residue CFO up to [5] ppm and | | |
| | residue timing offset up to [2] us | | |
| | Noise Figure (NF) = 6 GR UE NF | | |
| | Reception time up to one slot | | |
| | FR2 (including 24.25 GHz-52.6 GHz) | | |
| | Note: No implication on which | other sleep) | |
| | configuration(s) to be supported by 6 GR | | |
| | EE-processing can only be performed | | |
| | during a sleep state with an additional | | |
| | relative power value added with respect to | | |
| | the sleep state and without triggering UE | | |
| | transition out of the sleep state. | | |
| | Additional energy overhead [15], in unit of | | |
| | (relative power x ms), is included for each | | |
| | time entering or leaving EE processing | | |
| | during ultra-deep/deep sleep. Ramp-up or | | |
| | ramp-down time for EE processing is [2] | | |
| | ms. | | |
| PDCCH- | No PDSCH and same-slot scheduling; this | 100 | 175 |
| only | includes time for PDCCH decoding and any | | |
| | micro-sleep within the slot. | | |
| SSB or | SSB can be used for fine time-frequency | 100 | 175 |
| CSI-RS | sync. and RSRP measurement of the | | |
| proc. | serving/camping cell. TRS is the considered | | |
| | CSI-RS for sync. | | |
| PDCCH + | PDCCH + PDSCH. ACK/NACK in long | 300 | 350 |
| PDSCH | PUCCH is modeled by UL power state. | | |
| UL | Long PUCCH or PUSCH or PRACH | 250 (0 dBm) | 350 |
| | | X4 (10 dBm) | |
| | | X5 (15 dBm) | |
| | | X6 (20 dBm) | |
| | | 700 (23 dBm) | |
| | | X7 (26 dBm) | |

Table 3 includes example sleep states.

TABLE 3

| Power State | Characteristics | Relative Power |
|---|---|---|
| Ultra Deep | Time interval for the sleep should be larger than the total | 0.05 + Y* |
| Sleep | transition time entering and leaving this state. Accurate | |
| | timing or frequency may not always be maintained. | |
| Deep Sleep | Time interval for the sleep should be larger than the total | 1 + Y* |
| | transition time entering and leaving this state. Accurate | (Optional: 1) |
| | timing may not always be maintained. | |
| Light Sleep | Time interval for the sleep should be larger than the total | 20 |
| | transition time entering and leaving this state. | |
| Micro sleep | Immediate transition is assumed for power saving study | 45 |
| | purpose from or to a non-sleep state | |
| | Additional transition energy: | |
| Sleep type | (Relative power x ms) | Total transition time** |
| Ultra deep sleep | [40000] | [1600] ms |
| Deep sleep | 450 | 20 ms |
| Light sleep | 100 | 6 ms |
| Micro sleep | 0 | 0 ms* |

*Y value equals to 0.1, if EE processing is assumed for the evaluation; zero, otherwise.
*Immediate transition is assumed for power saving study purpose from or to a non-sleep state
**Ramp-up time is no less than half of the total transition time
***Time for sync/re-sync is not included

In aspects of this disclosure, cell reselection may be performed in an energy efficient power state. For example, regarding UE measurement capability in an energy efficient power state for idle mode cell re-selection purposes, the UE may be capable of monitoring at least: Intra-frequency carrier; depending on UE capability, ‘W’ inter-frequency carriers; depending on UE capability, ‘W’ FDD inter-RAT carriers; depending on UE capability, ‘W’ TDD inter-RAT carriers. Additionally, the UE may be capable of monitoring a total of at least ‘Q’ carrier frequency layers, which includes serving layer, including one or more of the above defined combination of inter-RAT, inter-frequency, or intra-frequency layers. In implementations, ‘W’, and/or ‘Q’ may be based on UE processing capability in an energy efficient power state within a sleep state. In implementations, W and Q may be less than (smaller than) the corresponding parameters associated with operation out of energy efficient power state or out of the sleep state.

A monitoring capability can be defined over both non-EE and energy efficient power states, and corresponding monitoring capability for each energy efficient power state can be determined according to a scaling formula of a reference monitoring capability: e.g., a relative power associated with the energy efficient power state (additional relative power value added regarding the sleep state) over a reference power (reference power can be power of non-sleep SSB state).

In implementations, monitoring in an energy efficient power state is performed according to the capability of the energy efficient power state. In an energy efficient power state, intra-frequency carriers may be monitored. Additionally, based on a scaling formula (e.g., as discussed above), a number of inter-frequency or inter-RAT carriers can be monitored. If a UE is capable of monitoring at least Q carrier frequency layers, the UE may monitor at least X intra-frequency carriers in an energy efficient power state. X can be determined from Q, and at least a parameter of the energy efficient power state (e.g., a relative power), and a parameter of a reference non-sleep power state (e.g., ‘X=Q*(a+P1)/P2’), where ‘a’ is an additional power for the energy efficient power state with respect to its sleep state, ‘P1’ is a relative power of the corresponding sleep state, and ‘P2’ is the relative power of the reference non-sleep power state. In another example, Z=Y*Q, wherein the UE may be capable of monitoring a total of at least ‘Z’ carrier frequency layers in an EE power state, and wherein ‘Y’ is a scaling factor (e.g., determined according to scaling of a power value in EE power state to a reference power value for a reference power state), and Q is a UE capability of monitoring a total of at least ‘Q’ carrier frequency layers in the reference power state, or Q is a nominal UE capability of monitoring a total of at least ‘Q’ carrier frequency layers, or Q is a reference capability.

Regarding serving cell measurements, in an energy efficient power state, a UE can measure the SS-RSRP and SS-RSRQ level of the serving cell and evaluate the cell selection criterion S defined in TS 38.304 for the serving cell at least once every M1*N1 DRX cycle. M1 can be based on the SMTC periodicity, and ‘N1’ can be based on the (e) DRX cycle length. One or more of M1, N1 can be based on the energy efficient power state and a corresponding sleep state. In the energy efficient power state, a UE may check if serving cell measurement in the energy efficient power state meets a quality threshold. If the cell measurement meets the quality threshold, the UE may skip intra-frequency measurements, lower/equal priority inter-frequency measurements, and/or inter-RAT measurements. The UE may perform higher priority inter-frequency measurements and inter-RAT measurements. The network can broadcast relaxed measurement (measurement rate reduction) features and related parameters (e.g., in SIB2) and if the UE supports such reduction, the UE can apply such relaxations on measurements.

Regarding cell reselection delay, if a cell reselection is triggered (e.g., if a high priority neighbor cell measure exceeds a threshold and threshold time (e.g., at least 1 second) since camping has elapsed, or if a serving cell quality measurement falls below a threshold), a UE may perform cell reselection within a specified time. The specified time (e.g., maximum end-to-end reselection delay which can be different for a newly detectable cell and an already detected cell, which can be different for intra-frequency and inter-frequency) may be longer than the time specified when the UE is not in the energy efficient power state.

For measurement time budgets T_{detect}, Tₘₑₐₛᵤᵣₑ, Tₑᵥₐₗᵤₐₜₑ, based on an energy efficient power state occurring in which sleep state, the time budgets for neighbor cell measurement/cell reselection can be determined. In implementations, a UE can determine the specified time for measurement time budgets based on the sleep state in which the energy efficient power state is operating. The specified time for measurement time budgets may be determined based on a broadcast signal, and the UE may determine in an energy efficient power state in which sleep states such measurements are possible based on the determined specified time for the measurement time budgets. In implementations, the UE may not perform serving cell and/or neighbor cell measurement in an energy efficient power state corresponding to particular sleep states, such as an ultra-deep sleep state or a deep sleep state, and the UE may perform serving cell and/or neighbor cell measurement in an energy efficient power state corresponding to particular sleep states, such as a light-sleep or a micro-sleep state. For specific sleep states, the UE can perform serving cell and/or neighbor cell measurement which can correspond to a UE capability. The UE may report (e.g., via capability reporting) a capability to perform serving cell and/or neighbor cell measurement in an energy-efficient power state associated with each sleep state.

Regarding measurement relaxation, a UE may enter relaxed measurement when certain conditions are satisfied (e.g., low-mobility, and/or not-at-the-cell-edge) for a period of time. A measurement relaxation factor (e.g., K1) can be different for an energy efficient power state in different sleep states. For instance, in a light sleep mode, K1=3 and in micro-sleep mode K1=2. Alternatively, or in addition, a measurement relaxation factor may be fixed (e.g., to K1=3), and measurement relaxation may be applicable in an energy efficient power state in particular sleep states. Measurement relaxation may be performed if a processing capability of the UE in an energy efficient power state within a sleep state exceeds a threshold. Such relaxation may enable more cells to be evaluated/measured within a time duration.

In implementations, conditions may apply to performing serving cell and/or neighbor cell measurement. In an energy efficient power state of some sleep states, the UE may not be able to perform all or part of serving cell and/or neighbor cell measurements due to processing complexity and/or power parameters. In an energy efficient power state, a UE may perform various operations. For example, the UE may check if serving cell measurement in an energy efficient power state meets a threshold. If the serving cell measurement in the energy efficient power state meets the threshold, the UE may skip intra-frequency measurements, lower/equal priority inter-frequency measurements, and inter-RAT measurements. The UE may perform higher priority inter-frequency measurements and inter-RAT measurements. Based on a UE processing capability, the UE may extend one or more of the timelines T_{detect}, Tₘₑₐₛᵤᵣₑ, and/or Tₑᵥₐₗᵤₐₜₑ.

In implementations, a UE may first perform measurement for previously detected cells, and if a data processing budget remains, the UE may then perform measurement for newly detected cells. The original timelines may be applicable to previously detected cells. The UE may reduce the number of higher priority inter-frequency measurements and inter-RAT measurements (e.g., from 7 to a smaller number) such that the UE can perform operations in the energy efficient power state within UE capability of processing/power limit in that state. For each energy efficient power state in a sleep state, a number ‘W’ can be defined and the UE can be capable of monitoring at least: W inter-frequency carriers; W FDD inter-RAT carriers (W1 inter-RAT 5G, and W2 inter-RAT EUTRA; where W1+W2=W); W TDD inter-RAT carriers (W1 inter-RAT 5G, and W2 inter-RAT EUTRA, wherein W1+W2=W) carriers. The UE may reevaluate the serving cell once every M′1*N′1 DRX cycle or ‘T’ time unit, wherein one or more of M′1, N′1, T′ are smaller or larger than M1, N1, T1 corresponding to normal serving cell measurement parameters. The UE may relax the serving cell measurement according to the above when a processing capability in the energy efficient power state exceeds a threshold usage.

In implementations, if the serving cell measurement in an energy efficient power state is below a quality threshold, the UE may transition into a non-sleep state or the UE may perform intra-frequency measurements with corresponding T_{detect}, Tₘₑₐₛᵤᵣₑ, Tₑᵥₐₗᵤₐₜₑ timelines determined by adding an offset or a scaling to a reference set of T_{detect}, Tₘₑₐₛᵤᵣₑ, Tₑᵥₐₗᵤₐₜₑ timelines. The scaling(s) or offset(s) may be determined based on a measurement load or a processing load in the energy efficient power state. In implementations, the UE caps measurements (drops/postpones measurements of some cells) such that the processing load is not larger than a processing threshold within a time duration. The processing threshold may be based on a processing capability of the UE in the energy efficient power state of the corresponding sleep state. A rule can be defined to determine which measurements can be dropped or postponed. For example, among equal or lower priority cells than the serving cell, the UE may drop/postpone cells with larger PCID or with PCIDs farther than the PCID of the serving cell.

In implementations, a UE may apply relaxation for one or more measurements such that a processing load is capped within a limit. A rule may be specified for applying measurement relaxation where relaxation applies to intra-frequency cells and equal or lower priority inter-frequency cells, or applies to high priority inter-frequency cells. A UE may fall back to normal parameters (instead of relaxed parameters) for serving cell measurements if the UE had switched to relaxed measurements in response to serving cell measurement meeting a quality threshold and the UE processing capability meeting a processing utilization threshold. In implementations a UE may not perform serving cell and/or neighbor cell measurement in an energy efficient power state if the processing capability of the UE corresponding to the energy efficient power state does not allow monitoring of a certain number of cells and/or cell reselection completion within a specified time.

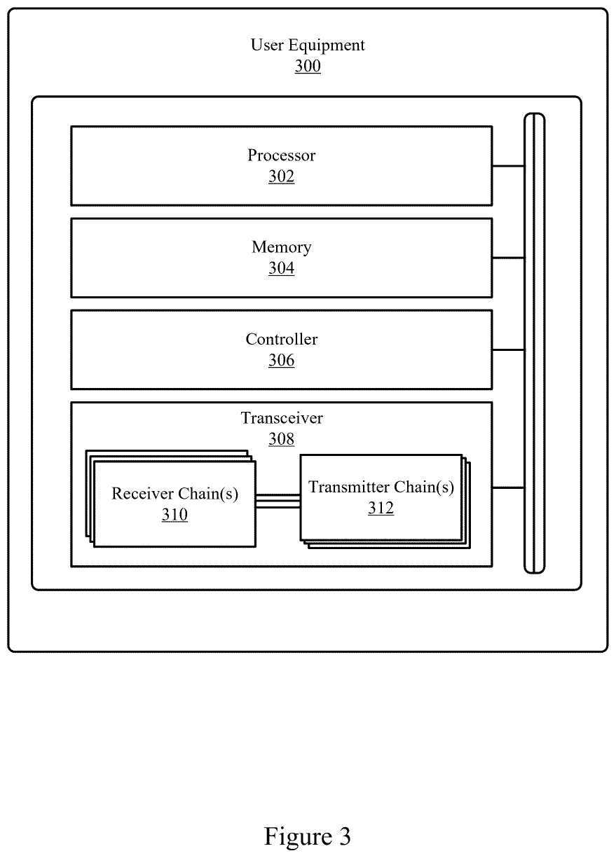

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a CPU, an ASIC, an FPGA, or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions that, when executed by the processor 302 cause the UE 300 to perform various functions described herein. The code may be stored in a non-transitory computer-readable medium such as the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein. The UE 300 may be configured to or operable to support a means for transitioning to a power state within a sleep state, the power state configured to enable the UE to perform data processing associated with cell measurement in the sleep state; and performing one or more neighbor cell measurements in the power state, wherein the one or more neighbor cell measurements are performed based at least in part on one or more capabilities associated with the power state and one or more capabilities associated with a reference power state.

Additionally, the UE 300 may be configured to support any one or combination of where the one or more capabilities associated with the power state include one or more of a power capability associated with the power state, or a data processing capability associated with the power state; the one or more capabilities associated with the power state include one or more of a minimum/maximum power capability associated with the power state, or a minimum/maximum data processing capability associated with the power state; the one or more capabilities associated with the reference power state include one or more of a reference power state or a reference data processing capability associated with the reference power state; the power state is associated with one or more of hardware availability or data processing availability in the power state; determining that the UE is in the power state within a time threshold of initiation of the power state; the one or more capabilities associated with the power state include one or more of one or more measurement capabilities for a total number of frequency cells, one or more measurement capabilities for a number of intra-frequency cells, one or more measurement capabilities for a number of inter-frequency cells, one or more measurement capabilities for a number of inter-RAT cells, a measurement time budget for intra-frequency cells, a measurement time budget for inter-frequency cells, or a measurement time budget for inter-RAT cells.

Additionally, the UE 300 may be configured to support any one or combination of where the measurement time budget for intra-frequency cells, the measurement time budget for inter-frequency cells, or the measurement time budget for inter-RAT cells includes a measurement time budget for one or more of: detecting a new cell that has not been detected; performing measurement on a cell according to a number of desired measurements per measurement window, wherein the measurement window and a number of measurements per measurement window are determined at least based on the measurement time budget and a measurement relaxation factor; or evaluating whether a newly detected or previously detected cell meets a cell reselection criterion; the reference power state includes a SSB processing state, and wherein the SSB processing state includes a non-sleep state or a micro-sleep state; using the SSB processing state for one or more of time-frequency synchronization or RSRP and/or RSRQ measurement of a serving cell and/or a set of neighbor cells of the UE.

Additionally, or alternatively, the UE 300 may support at least one memory (e.g., the memory 304) and at least one processor (e.g., the processor 302) coupled with the at least one memory and configured to cause the UE to transition to a power state within a sleep state, the power state configured to enable the UE to perform data processing associated with cell measurement in the sleep state; and perform one or more neighbor cell measurements in the power state, wherein the one or more neighbor cell measurements are performed based at least in part on one or more capabilities associated with the power state and one or more capabilities associated with a reference power state.

Additionally, the UE 300 may be configured to support any one or combination of where the one or more capabilities associated with the power state include one or more of a power capability associated with the power state, or a data processing capability associated with the power state; the one or more capabilities associated with the power state include one or more of a minimum/maximum power capability associated with the power state, or a minimum/maximum data processing capability associated with the power state; the one or more capabilities associated with the reference power state include one or more of a reference power state or a reference data processing capability associated with the reference power state; the power state is associated with one or more of hardware availability or data processing availability in the power state; the at least one processor is operable to cause the UE to: determine that the UE is in the power state within a time threshold of initiation of the power state; the one or more capabilities associated with the power state include one or more of one or more measurement capabilities for a total number of frequency cells, one or more measurement capabilities for a number of intra-frequency cells, one or more measurement capabilities for a number of inter-frequency cells, one or more measurement capabilities for a number of inter-RAT cells, a measurement time budget for intra-frequency cells, a measurement time budget for inter-frequency cells, or a measurement time budget for inter-RAT cells.

Additionally, the UE 300 may be configured to support any one or combination of where the measurement time budget for intra-frequency cells, the measurement time budget for inter-frequency cells, or the measurement time budget for inter-RAT cells includes a measurement time budget for one or more of: detecting a new cell that has not been detected; performing measurement on a cell according to a number of desired measurements per measurement window, wherein the measurement window and a number of measurements per measurement window are determined at least based on the measurement time budget and a measurement relaxation factor; or evaluating whether a newly detected or previously detected cell meets a cell reselection criterion; the reference power state includes a SSB processing state, and wherein the SSB processing state includes a non-sleep state or a micro-sleep state; the at least one processor is operable to cause the UE to: use the SSB processing state for one or more of time-frequency synchronization or RSRP and/or RSRQ measurement of a serving cell and/or a set of neighbor cells of the UE.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas to receive a signal over the air or wireless medium. The receiver chain 310 may include at least one amplifier (e.g., a low-noise amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

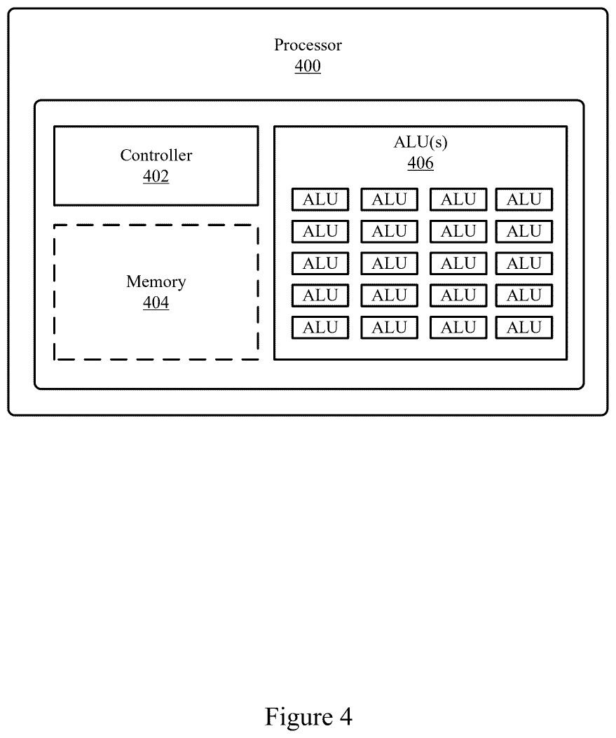

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory addresses of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, ALUs 406, and other functional units of the processor 400.

The memory 404 may include one or more caches (e.g., memory local to or included in the processor 400 or other memory, such as RAM, ROM, DRAM, SDRAM, SRAM, MRAM, flash memory, etc.). In some implementations, the memory 404 may reside within or on a processor chipset (e.g., local to the processor 400). In some other implementations, the memory 404 may reside externally to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, and the controller 402, and may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 may be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or operable to support at least one controller (e.g., the controller 402) coupled with at least one memory (e.g., the memory 404) and configured to cause the processor to transition to a power state within a sleep state, the power state configured to enable the UE to perform data processing associated with cell measurement in the sleep state; and perform one or more neighbor cell measurements in the power state, wherein the one or more neighbor cell measurements are performed based at least in part on one or more capabilities associated with the power state and one or more capabilities associated with a reference power state.

Additionally, the processor 400 may be configured to or operable to support any one or combination of where the one or more capabilities associated with the power state include one or more of a power capability associated with the power state, or a data processing capability associated with the power state; the one or more capabilities associated with the power state include one or more of a minimum/maximum power capability associated with the power state, or a minimum/maximum data processing capability associated with the power state; the one or more capabilities associated with the reference power state include one or more of a reference power state or a reference data processing capability associated with the reference power state; the power state is associated with one or more of hardware availability or data processing availability in the power state; the at least one controller is operable to cause the processor to: determine that the UE is in the power state within a time threshold of initiation of the power state; the one or more capabilities associated with the power state include one or more of one or more measurement capabilities for a total number of frequency cells, one or more measurement capabilities for a number of intra-frequency cells, one or more measurement capabilities for a number of inter-frequency cells, one or more measurement capabilities for a number of inter-RAT cells, a measurement time budget for intra-frequency cells, a measurement time budget for inter-frequency cells, or a measurement time budget for inter-RAT cells;

Additionally, the processor 400 may be configured to or operable to support any one or combination of where the measurement time budget for intra-frequency cells, the measurement time budget for inter-frequency cells, or the measurement time budget for inter-RAT cells includes a measurement time budget for one or more of: detecting a new cell that has not been detected; performing measurement on a cell according to a number of desired measurements per measurement window, wherein the measurement window and a number of measurements per measurement window are determined at least based on the measurement time budget and a measurement relaxation factor; or evaluating whether a newly detected or previously detected cell meets a cell reselection criterion; the reference power state includes a SSB processing state, and wherein the SSB processing state includes a non-sleep state or a micro-sleep state; the at least one processor is operable to cause the UE to: use the SSB processing state for one or more of time-frequency synchronization or RSRP and/or RSRQ measurement of a serving cell and/or a set of neighbor cells of the UE.

The processor 400 may support wireless communication in accordance with examples as disclosed herein. The processor 400 may be configured to or operable to support at least one controller (e.g., the controller 402) coupled with at least one memory (e.g., the memory 404) and configured to cause the processor to generate configuration for neighbor cell measurement of a user equipment (UE) in a power state within a sleep state, the power state configured to enable the UE to perform data processing associated with cell measurement in the sleep state, wherein the measurement configuration comprises one or more capabilities associated with a UE power state and one or more capabilities associated with a UE reference power state; and transmit the measurement configuration.

Additionally, the processor 400 may be configured to or operable to support any one or combination of where the reference power state includes a SSB processing state.

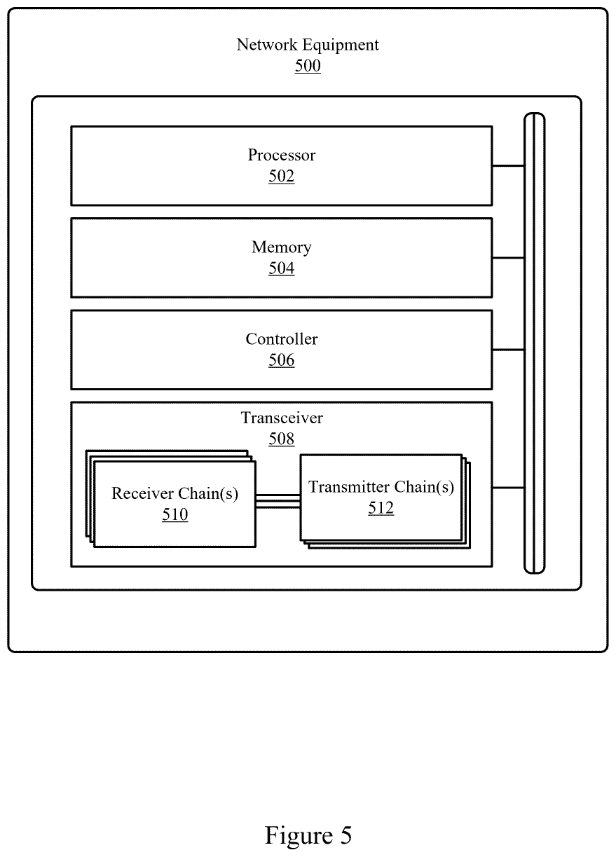

FIG. 5 illustrates an example of an NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions that, when executed by the processor 502 cause the NE 500 to perform various functions described herein. The code may be stored in a non-transitory computer-readable medium such as the memory 504 or another type of memory. Computer-readable media include both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein. The NE 500 may be configured to or operable to support a means for generating configuration for neighbor cell measurement of a user equipment (UE) in a power state within a sleep state, the power state configured to enable the UE to perform data processing associated with cell measurement in the sleep state, wherein the measurement configuration comprises one or more capabilities associated with a UE power state and one or more capabilities associated with a UE reference power state; and transmitting the measurement configuration.

Additionally, the NE 500 may be configured to or operable to support any one or combination of where the reference power state includes a SSB processing state.

Additionally, or alternatively, the NE 500 may support at least one memory (e.g., the memory 504) and at least one processor (e.g., the processor 502) coupled with the at least one memory and configured to cause the NE to generate configuration for neighbor cell measurement of a user equipment (UE) in a power state within a sleep state, the power state configured to enable the UE to perform data processing associated with cell measurement in the sleep state, wherein the measurement configuration comprises one or more capabilities associated with a UE power state and one or more capabilities associated with a UE reference power state; and transmit the measurement configuration.

Additionally, the NE 500 may be configured to support any one or combination of where the reference power state includes a SSB processing state.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

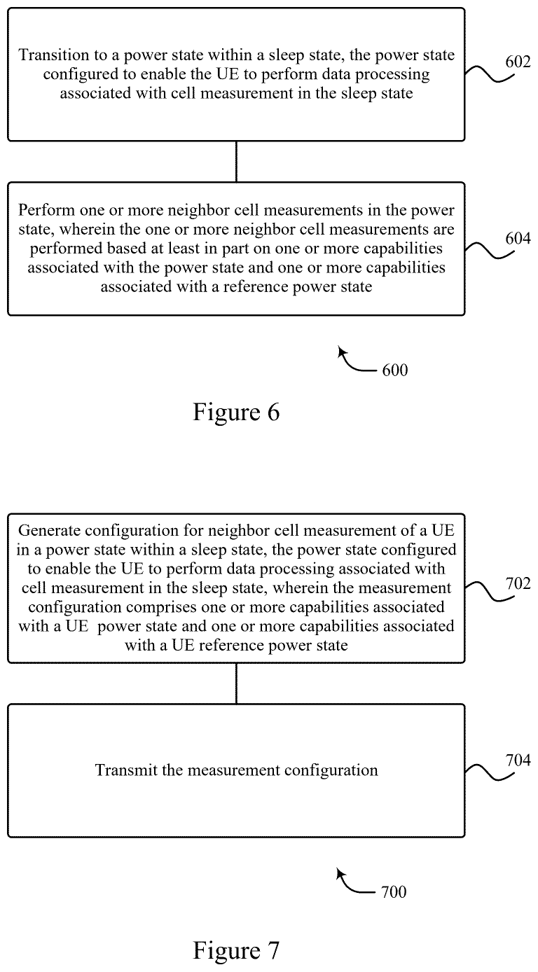

FIG. 6 illustrates a flowchart of a method 600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 602, the method may include transitioning to a power state within a sleep state, the power state configured to enable the UE to perform data processing associated with cell measurement in the sleep state. The operations of 602 may be performed in accordance with examples as described herein. In some implementations, aspects of the operations of 602 may be performed by a UE as described with reference to FIG. 3.

At 604, the method may include performing one or more neighbor cell measurements in the power state, wherein the one or more neighbor cell measurements are performed based at least in part on one or more capabilities associated with the power state and one or more capabilities associated with a reference power state. The operations of 604 may be performed in accordance with examples as described herein. In some implementations, aspects of the operations of 604 may be performed by a UE as described with reference to FIG. 3.

FIG. 7 illustrates a flowchart of a method 700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 702, the method may include generating configuration for neighbor cell measurement of a UE in a power state within a sleep state, the power state configured to enable the UE to perform data processing associated with cell measurement in the sleep state, wherein the measurement configuration comprises one or more capabilities associated with a UE power state and one or more capabilities associated with a UE reference power state. The operations of 702 may be performed in accordance with examples as described herein. In some implementations, aspects of the operations of 702 may be performed by an NE as described with reference to FIG. 5.

At 704, the method may include transmitting the measurement configuration. The operations of 704 may be performed in accordance with examples as described herein. In some implementations, aspects of the operations of 704 may be performed by an NE as described with reference to FIG. 5.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transition to a power state within a sleep state, the power state configured to enable the UE to perform data processing associated with cell measurement in the sleep state; and
perform one or more neighbor cell measurements in the power state, wherein the one or more neighbor cell measurements are performed based at least in part on one or more capabilities associated with the power state and one or more capabilities associated with a reference power state.

2. The UE of claim 1, wherein the one or more capabilities associated with the power state comprise one or more of a power capability associated with the power state, or a data processing capability associated with the power state.

3. The UE of claim 1, wherein the one or more capabilities associated with the power state comprise one or more of a minimum/maximum power capability associated with the power state, or a minimum/maximum data processing capability associated with the power state.

4. The UE of claim 1, wherein the one or more capabilities associated with the reference power state comprise one or more of a reference power state or a reference data processing capability associated with the reference power state.

5. The UE of claim 1, wherein the power state is associated with one or more of hardware availability or data processing availability in the power state.

6. The UE of claim 1, wherein the at least one processor is operable to cause the UE to:
determine that the UE is in the power state within a time threshold of initiation of the power state.

7. The UE of claim 1, wherein the one or more capabilities associated with the power state comprise one or more of one or more measurement capabilities for a total number of frequency cells, one or more measurement capabilities for a number of intra-frequency cells, one or more measurement capabilities for a number of inter-frequency cells, one or more measurement capabilities for a number of inter-radio access technology (RAT) cells, a measurement time budget for intra-frequency cells, a measurement time budget for inter-frequency cells, or a measurement time budget for inter-RAT cells.

8. The UE of claim 7, wherein the measurement time budget for intra-frequency cells, the measurement time budget for inter-frequency cells, or the measurement time budget for inter-RAT cells comprises a measurement time budget for one or more of:
detecting a new cell that has not been detected;
performing measurement on a cell according to a number of desired measurements per measurement window, wherein the measurement window and a number of measurements per measurement window are determined at least based on the measurement time budget and a measurement relaxation factor; or
evaluating whether a newly detected or previously detected cell meets a cell reselection criterion.

9. The UE of claim 1, wherein the reference power state comprises a synchronization signal block (SSB) processing state, and wherein the SSB processing state comprises a non-sleep state or a micro-sleep state.

10. The UE of claim 9, wherein the at least one processor is operable to cause the UE to:
use the SSB processing state for one or more of time-frequency synchronization or reference signal received power (RSRP) and/or Reference Signal Received Quality (RSRQ) measurement of a serving cell and/or a set of neighbor cells of the UE.

11. A network equipment (NE) for wireless communication, comprising:
at least one memory; and
at least one processor coupled with the at least one memory and operable to cause the NE to:
transmit measurement configuration for neighbor cell measurement of a user equipment (UE) in a power state within a sleep state, the power state configured to enable the UE to perform data processing associated with cell measurement in the sleep state, wherein the measurement configuration comprises one or more capabilities associated with a UE power state and one or more capabilities associated with a UE reference power state.

12. The NE of claim 11, wherein the reference power state comprises a synchronization signal block (SSB) processing state.

13. A method performed by a user equipment (UE), the method comprising:
transitioning to a power state within a sleep state, the power state configured to enable the UE to perform data processing associated with cell measurement in the sleep state; and
performing one or more neighbor cell measurements in the power state, wherein the one or more neighbor cell measurements are performed based at least in part on one or more capabilities associated with the power state and one or more capabilities associated with a reference power state.

14. The method of claim 13, wherein the one or more capabilities associated with the power state comprise one or more of a power capability associated with the power state, or a data processing capability associated with the power state.

15. The method of claim 13, wherein the one or more capabilities associated with the power state comprise one or more of a minimum power capability associated with the power state, or a minimum data processing capability associated with the power state.

16. The method of claim 13, wherein the one or more capabilities associated with the reference power state comprise one or more of a reference power state or a reference data processing capability associated with the reference power state.

17. The method of claim 13, wherein the power state is associated with one or more of hardware availability or data processing availability in the power state.

18. The method of claim 13, further comprising:
determining that the UE is in the power state within a time threshold of initiation of the power state.

19. The method of claim 13, wherein the one or more capabilities associated with the power state comprise one or more of one or more measurement capabilities for a total number of frequency cells, one or more measurement capabilities for a number of inter-frequency cells, one or more measurement capabilities for a number of inter-radio access technology (RAT) cells, a measurement time budget corresponding to intra-frequency cells, a measurement time budget corresponding to inter-frequency cells, or a measurement time budget corresponding to inter-RAT cells.

20. A method performed by a network equipment (NE), the method comprising:
transmitting measurement configuration for neighbor cell measurement of a user equipment (UE) in a power state within a sleep state, the power state configured to enable the UE to perform data processing associated with cell measurement in the sleep state, wherein the measurement configuration comprises one or more capabilities associated with a UE power state and one or more capabilities associated with a UE reference power state.
